(19) United States
(12) Patent Application Publication
(10) Pub. No.: US 2013/0018783 A1
(43) Pub. Date: Jan. 17, 2013

(54) Efficient Stored-Value Card Transactions

(71) Applicant: Ansar ANSARI, Santa Clara, CA (US)

(72) Inventor: Ansar ANSARI, Santa Clara, CA (US)

(73) Assignee: BLACKHAWK NETWORK, INC., Pleasanton, CA (US)

(21) Appl. No.: 13/621,331

(22) Filed: Sep. 17, 2012

Related U.S. Application Data
(63) Continuation of application No. PCT/US11/40055, filed on Jun. 10, 2011.
(60) Provisional application No. 61/354,469, filed on Jun. 14, 2010.
(60) Provisional application No. 61/354,470, filed on Jun. 14, 2010.
(60) Provisional application No. 61/360,327, filed on Jun. 30, 2010.

(51) Int. Cl. G06Q 20/22

(52) U.S. Cl. 705/39

(57) ABSTRACT

A method includes receiving a stored-value card transaction request from an access point. The stored-value card transaction request is associated with a package identification number, and the package identification number is associated with a plurality of stored-value cards. The method further includes generating a plurality of children transaction requests based on the stored-value card transaction request. The method further includes sending at least one of the plurality of children transaction requests to a first card party. The method further includes sending at least another of the plurality of children transaction requests to a second card party. The second card party may be the same or different from the first card party.

### CROSS-REFERENCE TO RELATED APPLICATIONS

This application is a continuation of and claims priority to International Application No. PCT/US2011/040055 filed on Jun. 10, 2011, published as WO 2011/159579 and entitled “Efficient Stored-Value Card Transactions” which is a non-provisional of U.S. Provisional Application Nos. 61/354,469 and 61/354,470, both filed on Jun. 14, 2010, and 61/360,327 filed on Jun. 30, 2010, each of which is incorporated herein by reference in its entirety.

### BACKGROUND

The market for stored-value cards, e.g. gift cards, continues to grow to unprecedented levels. As such, the current stresses on stored-value card systems have not been encountered, and more efficient transactions are necessary.

### SUMMARY OF THE INVENTION

Methods, networks, and storage mediums for efficient stored-value card transactions are disclosed. A method includes receiving stored-value card transactions and processing the stored-value card transactions. The method further includes using a linearly scalable grid computing network for settlement of the stored-value card transactions.

A machine-readable storage medium includes executable instructions that, when executed, cause one or more card parties to receive stored-value card transactions and process the stored-value card transactions. The one or more card parties are further caused to use a linearly scalable grid computing network for settlement of the stored-value card transactions.

A network includes an acquiring transaction service, an internal card processing service coupled to the acquiring transaction service, and a settlement service coupled to the internal card processing service. The acquiring transaction service receives stored-value card transactions, and the internal card processing service processes the stored-value card transactions. The settlement service uses a linearly scalable grid computing network for settlement of the stored-value card transactions.

A method includes receiving a stored-value card transaction request from an access point. The stored-value card transaction request comprises a card identification number or at least an indicia of a card identification number. The method further includes generating a plurality of children transaction requests based on the stored-value card transaction request. The method further includes sending at least one of the plurality of children transaction requests to a first card party. The method further includes sending at least another of the plurality of children transaction requests to a second card party. The second card party may be the same or different from the first card party. The stored-value card may be associated with the first and/or second card party.

A machine-readable storage medium includes executable instructions that, when executed, cause one or more card parties to receive a stored-value card transaction request from an access point. The stored-value card transaction request comprises a card identification number or at least an indicia of a card identification number. A plurality of children transaction requests are generated based on the stored-value card transaction request. At least one of a plurality of children transaction requests is sent to a first card party. At least one of a plurality of children transaction requests is sent to a second card party. The second card party may be different from the first card party. The stored-value card may be associated with the first and/or second card party.

A network includes an acquiring transaction service coupled to an internal card processing service. The acquiring transaction service receives a stored-value card transaction request, which is associated with a card identification number or at least an indicia of a card identification number. The internal card processing service determines card party associated with the card identification number or the indicia of the card identification number. The acquiring transaction service generates a plurality of children transaction requests based on the stored-value card transaction request. The acquiring transaction service sends at least one of the plurality of children transaction requests to a first card party. The acquiring transaction service sends at least another of the plurality of children transaction requests to a second card party. The second card party may be the same or different from the first card party.

The stored-value card transaction request may be associated with a package identification number, and the package identification number is associated with a plurality of stored-value cards. The method further includes generating a plurality of children transaction requests based on the stored-value card transaction request. The method further includes sending at least one of the plurality of children transaction requests to a first card party. The first card party is associated with at least one of the plurality of stored-value cards. The method further includes sending at least another of the plurality of children transaction requests to a second card party. The second card party is different from the first card party, and the second card party is associated with at least one of the plurality of stored-value cards.

A machine-readable storage medium includes executable instructions that, when executed, cause one or more card parties to receive a stored-value card transaction request from an access point. The stored-value card transaction request is associated with a package identification number, and the package identification number is associated with a plurality of stored-value cards. A plurality of children transaction requests are generated based on the stored-value card transaction request. At least one of a plurality of children transaction requests is sent to a first card party. At least one of a plurality of children transaction requests is sent to a second card party. The second card party may be different from the first card party. The stored-value card may be associated with the first and/or second card party.

A network includes an acquiring transaction service coupled to an internal card processing service. The acquiring transaction service receives a stored-value card transaction request, which is associated with a package identification number. The package identification number is associated with a plurality of stored-value cards, and the internal card processing service determines card parties associated with the package identification number. The acquiring transaction service generates a plurality of children transaction requests based on the stored-value card transaction request. The acquiring transaction service sends at least one of the plurality of children transaction requests to a first card party, and the first card party is associated with at least one of the plurality of stored-value cards. The acquiring transaction service sends at least another of the plurality of children transaction requests to a second card party. The second card party is different from the first card party, and the second card party is associated with at least one of the plurality of stored-value cards.

A method includes receiving a stored-value card activation request associated with a stored-value card. The method further includes determining that the stored-value card is already active. The method further includes generating a replenish request based on the stored-value card activation request and sending a confirmation of successful execution of the stored-value card activation request upon successful execution of the replenish request.

A network includes an acquiring transaction service coupled to an internal card processing service. The acquiring transaction service receives a stored-value card activation request associated with a stored-value card. The acquiring transaction service generates a replenish request, based on the stored-value card activation request, and sends the replenish request to the internal card processing service. The internal card processing service determines that the stored-value card is already active. The acquiring transaction service sends a confirmation of successful execution of the stored-value card activation request upon successful execution of the replenish request.

A method includes receiving a stored-value card activation request associated with a stored-value card. The method further includes attempting to execute a replenish request based on the stored-value card activation request, and attempting to execute the stored-value card activation request based on failure to execute the replenish request. The method further includes sending a confirmation of successful execution of the stored-value card activation request upon successful execution of the stored-value card activation request.

A network includes an acquiring transaction service coupled to an internal card processing service. The acquiring transaction service receives a stored-value card activation request associated with a stored-value card and sends a replenish request, based on the stored-value card activation request, to the internal card processing service. The internal card processing service sends a declination to the acquiring transaction service in response to the replenish request. The acquiring transaction service sends an activation request, associated with the stored-value card, to the internal card processing service in response to the declination. The internal card processing service sends a confirmation of successful execution of the activation request to the acquiring transaction service upon successful execution of the activation request.

A machine-readable storage medium includes executable instructions that, when executed, cause one or more processors to receive a stored-value card activation request associated with a stored-value card. The one or more processors are further caused to attempt to execute a replenish request based on the stored-value card activation request and attempt to execute the stored-value card activation request based on failure to execute the replenish request. The one or more processors are further caused to send a confirmation of successful execution of the stored-value card activation request upon successful execution of the stored-value card activation request.

### BRIEF DESCRIPTION OF THE DRAWINGS

FIG. 1 illustrates a physical view of a stored-value card network in accordance with at least some illustrated embodiments;

FIGS. 2 and 3 illustrate a logical view of a stored-value card network in accordance with at least some illustrated embodiments;

FIG. 4 illustrates a particular machine suitable for implementing several embodiments of the disclosure;

FIGS. 5-8 illustrate methods of stored-value card processing in accordance with at least some illustrated embodiments.

### DETAILED DESCRIPTION OF THE PREFERRED EMBODIMENTS

As used herein, stored-value card refers to a card that may be used to transact business with a party willing to accept the card, for example as tender for a purchase. Examples of such cards include credit cards, debit cards, gift cards, telephone cards, loyalty cards, membership cards, ticket cards, entertainment cards, sports cards, prepaid cards, and the like. Stored-value cards may have various affiliated or non-affiliated card issuers. In at least one embodiment, the cards are wallet-sized and made of plastic. In various embodiments, the stored-value card may be a type of card such as a gift card or prepaid card that requires activation at a point of sale. For example, a stored-value card may be purchased and activated at a point of sale by a consumer and subsequently used by the consumer or another to transact business.

Consumer use of transaction cards typically involves a card vendor, a redeeming merchant, a transaction facilitator, a transaction processor, a card processor, and a card issuer (generally, “card party”). In various embodiments, the card vendor, redeeming merchant, the transaction facilitator, the transaction processor, the card processor, and the card issuer may be the same, different, related entities, or combinations thereof. The point of sale where transaction cards are purchased and activated may be referred to as the card vendor or simply vendor. An entity that will accept a transaction card for business transactions, for example as tender for a purchase, may be referred to as a redeeming merchant. An entity that provides a means for other card parties to communicate concerning a transaction card transaction may be referred to as a transaction facilitator. An entity that provides card parties information, validation and/or authorization for card transactions may be referred to as a transaction processor. An entity that provides the financial backing via the transaction card may be referred to as the card issuer or simply issuer. An entity that manages card transactions for a card issuer may be referred to as a card processor.

In at least one embodiment, the issuer is identified on the stored-value card and associates a unique issuer account code with each stored-value card. Card issuers include direct issuers of cards such as store-branded cards, and in some embodiments the card vendor may also be the card issuer and/or the redeeming merchant. Card issuers also include banks, financial institutions, and transaction processors such as VISA, MasterCard, American Express, etc., and cards issued by such institutions may be readily accepted by a number of redeeming merchants to conduct transactions such as purchases. In some instances, the redeeming merchant may be identified on the stored-value card (for example, a retailer branded card such as Store X), and such cards may be sold at the same or different card vendor (e.g., card vendor is Store X or a different or unrelated Store Z). In such instances, the Store X branded stored-value card may be issued by Store X, by Store Z, or by a third party such as bank or financial institution.

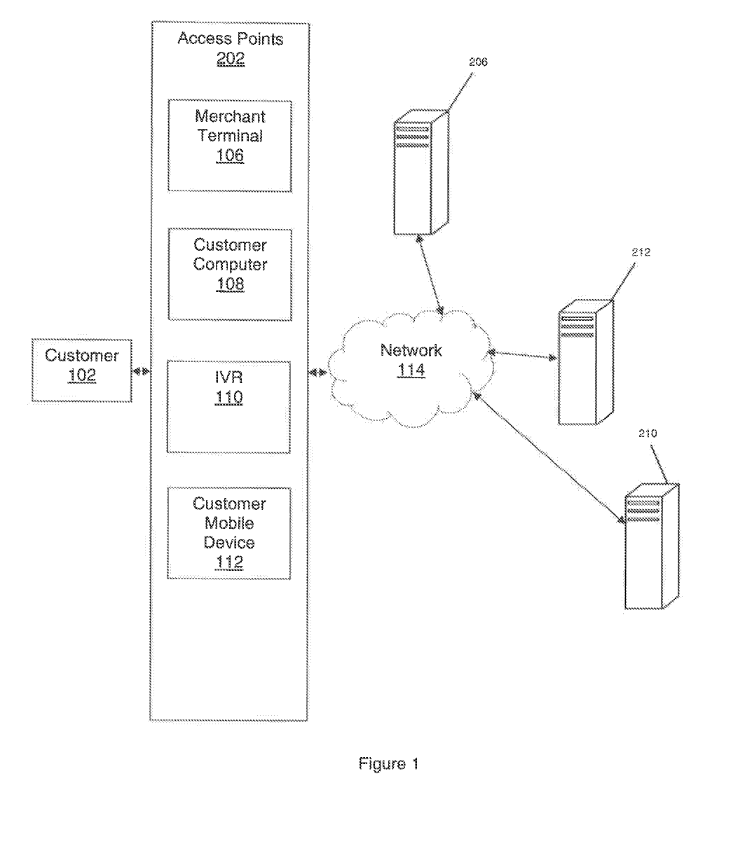

FIG. 1 illustrates a physical view of various components of a stored-value card transaction. In at least one embodiment, a customer 102 activates or replenishes a stored-value card at an access point 202. An access point 202, or point of sale component 311, is an interface through which the customer communicates with a multicard transaction system. The access point 202 can be operated and/or owned by the customer 102 or by the vendor (e.g. through a store clerk and/or pay station). Some examples of access points 202 are a merchant terminal 106, a customer-owned computer 108, an interactive voice response (“IVR”) system 110, a customer-owned mobile device 112, a phone network, a merchant-owned computer, etc. Because a customer interacts with the access point 202, the access point is sometimes called the front end. The front end is coupled to the back end by a network 114. In at least one embodiment, the network 114 is the Internet. Some other examples of networks 114 are a phone network, a wireless network, an intra-net network, a packet-switching network, etc. As illustrated, the back end comprises three servers or switches 206, 210, 212, each for a particular service, but services may be distributed or collected among the back-end hardware. The acquiring transaction service 206 may function as a facilitator and is utilized to direct transaction requests and responses to the appropriate processors, services, and requesting entities. In at least one embodiment, the acquiring transaction service 206 is a switch. When a message is received at the acquiring transaction service 206, the acquiring transaction service 206 validates the formatting of the message. In other words, the acquiring transaction service 206 will check the data fields in the message to confirm that the field is populated with data and that the data is in the correct format (e.g., length, alphanumeric format). If the message is improperly formatted, the acquiring transaction service 206 will reject the transaction request. The transactions requests used as examples in this disclosure are predominantly activation requests and replenishment requests, but all other transaction requests, e.g. inquiry requests, deactivation requests, etc., are within the scope of this disclosure.

The acquiring transaction service 206 performs various validation checks on the transaction request. The acquiring transaction service 206 verifies card-related transaction information based on an analysis of several criteria, such as: 1) determining that the UPC code for the product is present in the a data grid 208 for the multicard transaction system; 2) determining that the value amount of the requested transaction corresponds to the customer's payment for the subject request, e.g., whether the UPC information identifies the card as a $25.00 card in the data grid 208 and that the corresponding transaction request includes a $25.00 payment by the customer; 3) determining that the UPC information identifies the card as being a type of card available for processing by the requesting merchant in the data grid 208; and 4) determining that the Bank Identification Number (“BIN”) of the card (i.e., the first six digits of the card's identification number), which identifies the card issuer, corresponds to the UPC information identifying the card issuer in the data grid 208.

The acquiring transaction service 206 may also reject transactions based on other criteria such as transaction velocity (number/amount per unit time). For example, if a card processor is concerned that multiple void transactions are indicative of fraudulent activity, the card processor could ask that the acquiring transaction service 206 monitor the number of void transactions requested and reject transactions from terminals that exceed a pre-selected amount of void transactions per unit time. Lastly, the acquiring transaction service 206 is configured to reject transaction requests in the event that the information received by the acquiring transaction service 206 is unintelligible.

If the message is properly formatted and is validated as described above, the acquiring transaction service 206 forwards the transaction information to the appropriate card processor, e.g., issuer, facilitator, merchant, and/or vendor. The card processor decides whether to reject the transaction request and/or perform the transaction request. The acquiring transaction service 206 will receive the transaction response from said processor (e.g., approval, denial, etc.) and direct the response to the source from whom the acquiring transaction service 206 acquired the message.

The internal card processing service 212 is used to support activities as a stored-value card issuer, facilitator, and/or vendor. In at least one embodiment, the internal card processing service 212 is a server. The internal card processing service 212 processes card-related transactions based on an analysis of several criteria, including: 1) determining that no transaction was requested (e.g., balance inquiry) for the particular card prior to activation and that a preset amount of time (e.g., 30 minutes) has expired between activation and first attempt to redeem, either of which may be an indicator of fraudulent activity; 2) determining that the particular card has not already been activated; 3) determining that the card's identification number is present in the data grid 208; 4) determining that the particular card's expiration date matches the card's information contained in the data grid 208; 5) determining that the requested activation amount, e.g., $25.00, corresponds to the amount allowed for the requested card type (e.g., UPC information such as $25.00 Store X card) pursuant to the card-type's product specifications maintained in the data grid 208; 6) determining that the spending limit of the particular card has not been exceeded; and 7) determining that the particular card's security code transmitted in the transaction request corresponds to the security code assigned to the card as maintained in the data grid 208.

If one or more of the above-recited determinations is not affirmatively verified, the internal card processing service 212 will reject the requested transaction. If the internal card processing service 212 confirms that all of the above criteria are affirmatively met, the internal card processing service 212 will process the requested transaction and provide a transaction response (e.g., approval, denial, etc.) to the acquiring transaction service 206 for communication to access points 202 and vendors or card issuers via their own authorization systems 204.

The settlement service 210 reconciles transactions with card issuers and vendors. The settlement service 210 records transactions and outputs the transactions in files formatted for card issuer authorization systems 204. The settlement service 210 can use different protocols for different card issuers including different settlement frequencies, multiple cutoff times, settlement across products or by individual products, multi-party settlements, multi-currency settlements, complex fee and commission structures, and the reporting associated with each of the above.

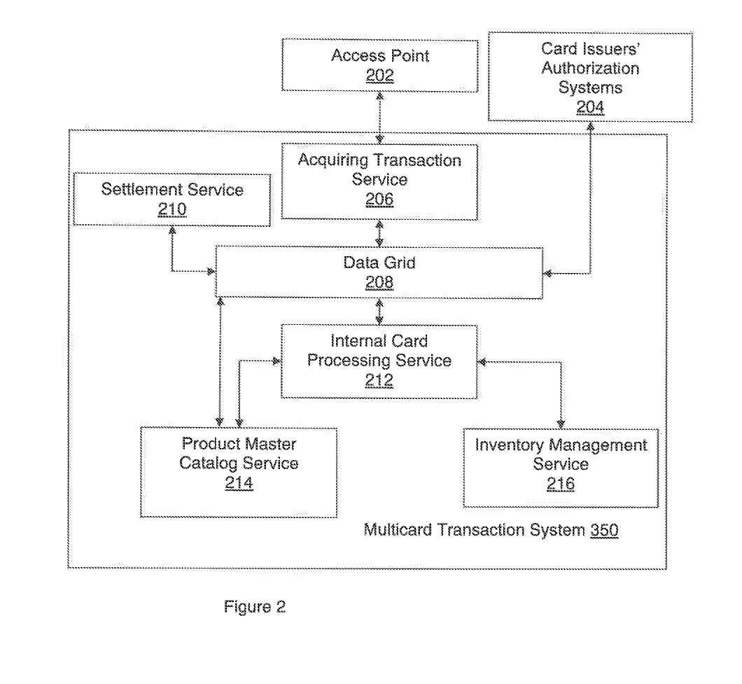

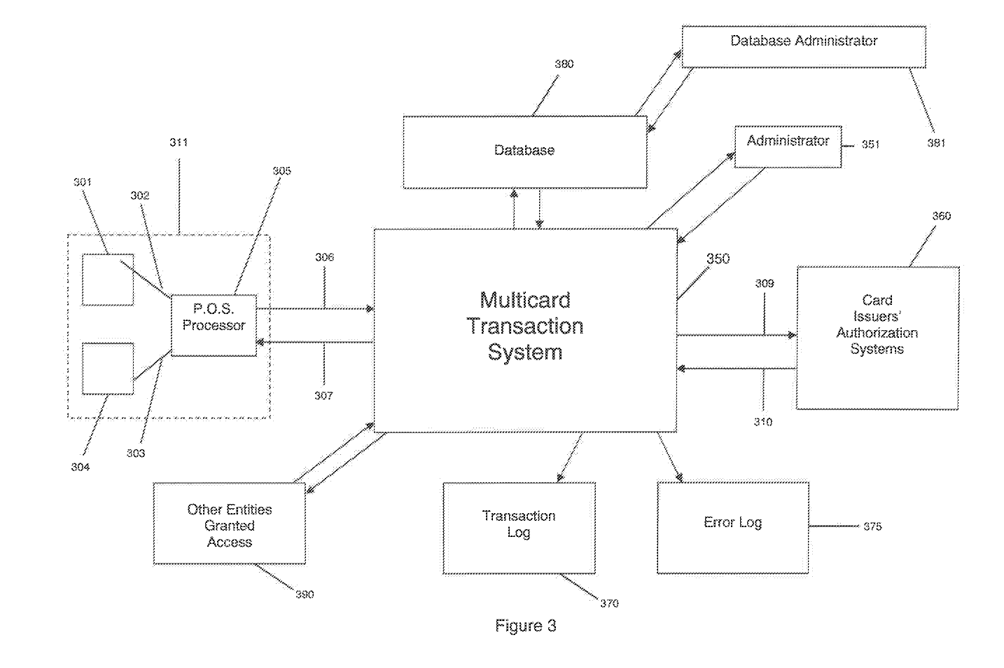

FIGS. 2 and 3 illustrate a logical view of a stored-value card network. In FIG. 2, multiple card issuers are represented by the card issuers' authorization systems 204, which are coupled to the multicard transaction system 350. The multicard transaction system 350 comprises an acquiring transaction service 206, a data grid 208, a settlement service 210, an internal card processing service 212, and may further comprise a product master catalog service 214, and an inventory management service 216. FIG. 2 illustrates just one example of out of many of how these services may be coupled.

In at least one embodiment, the multicard transaction system 350 comprises an acquiring transaction service 206, an internal card processing service 212 coupled to the acquiring transaction service 206, and a settlement service 210 coupled to the internal card processing service 212. As shown, the various services are coupled through a data grid 208. The data grid 208 is a linearly scalable grid computing network. The main attributes of the data grid 208 are memory and processing power. The acquiring transaction service 206 receives stored-value card transactions, and the internal card processing service 212 processes the stored-value card transactions. The settlement service 210 uses the data grid 208 for settlement of the stored-value card transactions. In at least one embodiment, the settlement service 210 settles the transaction on a real time or near real-time basis. Specifically, there is no intentional delay between processing the stored-value card transactions and settlement of the stored-value card transactions, i.e., the transactions are not “batch processed.” Batch processing refers to introducing an intention delay between processing and settlement. As such, batch processing settles multiple transactions at once, perhaps when network traffic is not as dedicated to processing, but increases the risk of service level agreement (“SLA”) violations and settlement errors.

As opposed to batch processing, real time or near real-time processing allows transactions to be “trickle fed” to the settlement service 210, which leverages the data grid 208 to store and/or process transaction information. Furthermore, each entity associated with stored-value cards can adapt to changing conditions much faster using real time or near real-time settlement by responding to and adjusting various metrics. As such, large-scale failure is highly unlikely, and small failures only affect a minimal number of transactions before they are addressed.

In at least one embodiment, the acquiring transaction service 206 receives a stored-value card transaction request. For example, the request results from an access point 202 scan of a stored-value card's universal product code (“UPC”) and/or a swipe of the stored-value card's magnetic strip (such scenarios contemplate activation of the stored-value card by either a one-step or a two-step activation process as fully described in U.S. Pat. No. 7,607,574, which is incorporated by reference in its entirety). As such, the request is associated with a card identification number. For example, a bank identification number (“BIN”) is transmitted with the request, and the acquiring transaction service 206 transmits the BIN to the internal card processing service 212. The internal card processing service 212 determines card issuer associated with the package identification number. For example, the internal card processing service 212 queries a database that returns that the BIN is associated with card issuer X, and the internal card processing service 212 transmits this information to the acquiring transaction service 206. The acquiring transaction service 206 tailors each activation request to the particular format of the card issuer, and sends the activation request to the card issuer's authorization system 204. Confirmation of a successful execution of the activation request is returned in at least one embodiment.

In at least another embodiment, the acquiring transaction service 206 receives a stored-value card transaction request. For example, the request results from an access point 202 scan of a multicard package's universal product code (“UPC”) and/or a swipe of the multicard package's magnetic strip. For example, a bank identification number (“BIN”) is transmitted with the request, and the acquiring transaction service 206 transmits the BIN to the internal card processing service 212. The internal card processing service 212 determines card issuers associated with the package identification number. For example, the internal card processing service 212 queries a database that returns that the BIN is associated with a package of 5 gift cards, each backed by a different card issuer, and the internal card processing service 212 transmits this information to the acquiring transaction service 206. The acquiring transaction service 206 generates a plurality of children transaction requests based on the stored-value card transaction request, and sends at least one of the plurality of children transaction requests to a first card issuer, which is associated with at least one of the plurality of stored-value cards. The acquiring transaction service 206 sends at least another of the plurality of children transaction requests to a second card issuer 204, which is associated with at least one of the plurality of stored-value cards but is different from the first card issuer. For example, the acquiring transaction service 206 generates 5 children transaction requests, one for each card issuer, and each request is an activation request for a card issuer's particular card in the package. The acquiring transaction service 206 tailors each activation request to the particular format of the card issuer, and sends the activation requests to the each card issuers' authorization systems 204. Confirmation of successful executions of the activation requests are returned in at least one embodiment. As such, each of the 5 cards in the multicard package is activated via only one scan of the package's UPC and/or magnetic strip despite the different card issuer for each card.

The following will describe stored-value card uses and functionalities in a telecommunications support context, however, it should be understood that this is simply a matter of convenience and efficiency and that any genre of commercial applications of stored-value card usage is contemplated under this disclosure.

In at least one embodiment, the acquiring transaction service 206 receives a stored-value card activation request associated with a stored-value card. For example, a customer 102 wishes to replenish her already active phone card with minutes, and selects a replenishing option on an access point 202 graphical user interface (“GUI”) at a vendor kiosk. However, it would be too expensive to retrofit every access point 202 to send replenish requests rather than activation requests. As such, the back-end must distinguish between activation requests intended for activation and activation requests intended for replenishment. In at least one embodiment, the acquiring transaction service 206 generates a replenish request, based on the stored-value card activation request, and sends the replenish request to the internal card processing service 212. For example, an account identifier, such as a BIN, is associated with the request. The internal card processing service 212 determines that the stored-value card is already active. If the card is already active, the activation request can be assumed to be intended for replenishment. If the card is not already active, the activation can be assumed to be intended for activation. At this point, either the acquiring transaction service 206 or the internal card processing service 212 can generate a second replenish request formatted for the card issuer 204, or the multicard transaction system 350 can handle the replenish request internally. If the acquiring transaction service 206 generates the request, the internal card processing service 212 sends a phone number associated with the stored-value card to the acquiring transaction service 206 to associate with the request. In either case, the acquiring transaction service 206 sends a confirmation of successful execution of the stored-value card activation request upon successful execution of the replenish request. Because the access point 202 is not equipped for handling replenish requests, the access point 202 will also not be equipped for handling confirmation messages of successful execution of replenish requests. As such, confirmation of activation is sent instead.

In an alternative embodiment, the acquiring transaction service 206 determines that the internal card processing service issued the stored-value card. For example, Telecom Company Z contracts with a stored-value card processing company to issue the type of phone card used by the customer 102. As such, the internal card processing service 212, rather than Company Z's back-end 204, will store customer account information. Accordingly, the acquiring transaction service 206 sends a redemption request to the internal card processing service 212. In either case, the acquiring transaction service 206 sends a confirmation of successful execution of the stored-value card activation request upon successful execution of the replenish request.

In at least one embodiment, the acquiring transaction service 206 receives a stored-value card activation request associated with a stored-value card. For example, a customer 102 wishes to activate a phone card by entering a BIN onto a website using her computer 108. The acquiring transaction service 206 identifies the stored-value card as issued from the internal card processing service 212. The acquiring transaction service 206 sends a replenish request based on the stored-value card activation request, to the internal card processing service 212, similar to the process described above. However, the internal card processing service 212 sends a declination to the acquiring transaction service 206 in response to the replenish request because the stored-value card is not active. As such, the acquiring transaction service 206 sends an activation request, associated with the stored-value card, to the internal card processing service 212 in response. The internal card processing service 212 sends a confirmation of successful execution of the activation request to the acquiring transaction service 206 upon successful execution of the activation request. In at least one embodiment, the acquiring transaction service 206 forwards the confirmation to the access point 202 and vendor associated with the stored-value card.

In an embodiment wherein a telecom customer desires to redeem a stored-value card associated with variable reload/recharge/top-up functionality, the customer may interact with the multicard transaction system 350 via an interactive voice response (“IVR”) system 110 and/or another type of access point (e.g., web portal, kiosk). The stored-value card will have an associated value, amount, and or denomination. For ease of discussion, the redemption scenario will be presented in the IVR system 110 context with the understanding that other access points 202 could be substituted for the IVR system 110 to achieve the same desired results.

To effectuate redemption of the stored-value card associated with variable reload/recharge/top-up functionality, the customer initiates communication with the multicard transaction system 350. For example, the customer calls a phone number associated with the IVR system 110 (said phone number is representative of multicard transaction system 350 communication information which is associated with the stored-value card and which the customer receives in conjunction with possession of the stored-value card). Upon initiating communication with the IVR system 110, the IVR system 110 prompts the customer to enter the identifying information of the customer's device (e.g., phone number, mobile identification number, etc.) intended for registration and association with the stored-value card. Upon receipt of the identifying information, the IVR system 110 validates the information (e.g., correct form, correct length, correct format for said information) and prompts the customer to enter a personal identification number (“PIN”) that is associated with the stored-value card (the PIN may be printed on the stored-value card, printed the stored-value card's packaging, and/or printed on a receipt concerning the stored value card). The PIN may be any combination of alpha numeric characters, and/or symbols, for example, the PIN may comprise twelve numerals. Upon receipt of the PIN, the IVR system 110 transmits a redemption request to the internal card processing service 212. The internal card processing service 212 validates the PIN and ensures that the stored-value card is activated but has yet to be associated with a customer's device. The internal card processing service 212 generates a reload/recharge/top-up request and transmits said request to the acquiring transaction service 206. The reload/recharge/top-up request comprises the customer's device identifying information and the stored-value card's associated value, amount, and/or denomination. The acquiring transaction service 206 transmits the request to a telecom carrier associated with the stored-value card. The carrier applies the stored-value card's value, amount, and/or denomination to the customer's device and transmits a representative response to the acquiring transaction service 206. Upon receiving the representative response from the carrier, the acquiring transaction service 206 transmits the representative response to the internal card processing service 212. If the request is approved, the internal card processing service 212 associates the customer's device identifying information with a customer account and/or the stored-value card's identification number. The customer account (or the stored-value card's associated value) is then set to zero balance. If the request is declined, the IVR system 110 notifies the customer with an error message received from the carrier and/or notifies the customer that the request will be processed in twenty-four hours. If approved, the IVR system 110 provides the customer with the carrier's name; device identifying information; amount, value, and/or denomination of the stored-value card; and the customer account and/or the stored-value card's identification number. The IVR system 110 provides the customer with a notification that the customer's device has been successfully recharged. If any issues arise during this redemption/recharge process, the customer is provided with information allowing the customer to contact the multicard transaction system's representatives for assistance.

In an embodiment wherein a telecom customer desires to reload/recharge/top-up a telecom device, the acquiring transaction service 206 receives a request to activate a stored-value card associated with variable reload/recharge/top-up functionality. The request may be initiated from a point of sale terminal or other access point and includes and amount for said reload/recharge/top-up. The acquiring transaction service 206 identifies the card processor as internal card processing service 212. The acquiring transaction service 206 transmits the reload/recharge/top-up request to the internal card processing service 212.

In a first embodiment of the reload/recharge/top-up scenario, the internal card processing service 212 approves the request if the stored-value card is activated and associated with a phone number. The internal card processing service 212 determines the telecom account associated with the phone number and adds the requested reload/recharge/top-up amount to the account. The internal card processing service 212 sends a response to the request (e.g., indicating that the reload/recharge/top-up amount has been added to the associated account), which comprises the phone number, to the acquiring transaction service 206. The acquiring transaction service 206 transmits a reload/recharge/top-up transaction request to the phone number's associated telecom carrier. Upon receiving approval of the reload/recharge/top-up transaction request from the telecom carrier, the acquiring transaction service 206 transmits a redemption transaction to the internal card processing service 212. The internal card processing service 212 sets the account balance to zero and transmits an approval response to the acquiring transaction service 206. If the reload/recharge/top-up transaction request is not approved by the telecom carrier, the acquiring transaction service 206 transmits a reversal request to the internal card processing service 212 which removes the requested reload/recharge/top-up amount from the account associated with the phone number. The acquiring transaction service 206 transmits a reload/recharge/top-up transaction request response to the originating access point.

In another embodiment of the reload/recharge/top-up scenario, the internal card processing service 212 approves the request if the stored-value card is activated and associated with a phone number. The internal card processing service 212 transmits a reload/recharge/top-up transaction request to the acquiring transaction service 206. The acquiring transaction service 206 transmits the reload/recharge/top-up transaction request to the phone number's associated telecom carrier. The acquiring transaction service 206 transmits the reload/recharge/top-up transaction request response to the internal card processing service 212. If the reload/recharge/top-up transaction request is approved by the telecom carrier, the internal card processing service 212 transmits an approval message to the acquiring transaction service 206. If the reload/recharge/top-up transaction request is not approved by the telecom carrier, the internal card processing service 212 transmits a rejection message to the acquiring transaction service 206. The acquiring transaction service 206 transmits the reload/recharge/top-up transaction request to the originating access point.

In at least one embodiment, a linearly scalable grid computing network is used for settlement of stored-value card transactions. The linearly scalable grid computing network comprises a plurality of different architectural components. These components comprise: a data grid with various spaces therein; a database; a set of application programming interfaces (“APIs”) allowing for data grid access; real-time processes; a data manager; and container wherein reside certain real-time processes, the data manager, the set of APIs allowing for data grid access, and the data grid. Ultimately, the linearly scalable grid computing network allows for more efficient and higher volumes of transaction processes (e.g., 200 transactions per second, four million transactions per every six hours).

Real time (or near real time) processes are responsible connecting to various data sources, acquiring transactions from the data sources, data validation, fee calculations and inserting information into a settlement database. Certain of these real time processes comprise processes for connecting the linearly scalable grid computing network to differing data sources (e.g., different transaction processing switches and/or platforms). Other of these real time processes comprise processes for inserting transaction data into temporary data tables allowing for faster data access. Other of these real time processes comprise processes (e.g., based on bit map value) for continuously querying certain data tables (e.g., temporary data tables), applying business logic and updating data tables with results along with updated bitmap. Other of these real time processes comprise processes for inserting transaction information into one table while removing the transactions from another table (e.g., inserting transaction information into a permanent table and removing the transaction from a temporary table).

The linearly scalable grid computing network allows for all transactional data to be stored in a memory grid for faster data retrieval and update. The grid is partitioned with redundancy and fail over support. Support is added to all real time processes to enable the real time processes to be deployed as services by which multiple instances of the same real time process can be deployed and managed. These multiple instances of the real time processes may read data in data spaces, perform business logic, and update data in the data spaces.

Specifically, three data spaces are contemplated. These three data spaces comprise Transaction Data Space, Master Data Space, and Summary Data Space. Transaction Data Space is the data space for transaction data. Master Data Space is the data space for master data, which is reference data and will be updated periodically by certain of the multiple instances of the real time processes. Summary Data Space is the data space for summary data that may be used by batch processes.

FIG. 3 illustrates a multicard transaction system 350 coupled to various other components. FIG. 3 includes: (a) at least one point of sale component 311; (b) a multicard transaction system 350; (c) a database 380 of package identifiers and individual stored-value card identifiers; (d) at least one individual card issuer's authorization system 360; and (e) any other component included in the system by the multicard transaction system administrator 351. The system is adapted to respond to various stored-value card request transactions, with each of the stored-value cards and/or multicard packages bearing unique identifiers. As can be seen in FIG. 3, at the point of sale, the various identifiers are interpreted 302 by a point of sale interpretation component 301. The point of sale interpretation component 301 can comprise a human, a bar code scanner, magnetic strip reader, optical character recognition device, or other device configured to interpret the data encoded in the various identifiers.

Contemporaneously with the interpretation of the identifier, a request for activation or deactivation 303 by a point of sale transaction component 304 is made. The point of sale transaction component 304 can comprise a human, an electronic input device, a register, a computer processing unit (“CPU”), or other means of requesting the activation or deactivation of the package identifier interpreted by the point of sale interpretation component 301. For purposes of disclosure, the actions performed by the point of sale interpretation component 301 and the point of sale transaction component 304 may be performed by one component capable of performing both actions that would be performed by the individual components.

The point of sale interpretation component 301 and the point of sale transaction component 304 communicate with the point of sale processing component 305. The point of sale processing component 305 can comprise a CPU or other type of processing device accepted for use in the industry. The point of sale interpretation component 301 communicates the identifier to the point of sale processing component 305. The point of sale transaction component 304 communicates the request for activation or deactivation of the identifier interpreted by the point of sale interpretation component 301 to the point of sale processing component 305. The point of sale processing component 305 correlates the identifier interpreted by the point of sale interpretation component 301 with the request for activation or deactivation made by the point of sale transaction component 304 and communicates the request 306 for activation or deactivation of the identifier to the multicard transaction system 350. For purposes of disclosure, the actions performed by the point of sale interpretation component 301, the point of sale transaction component 304, and the point of sale processing component 306 may all be performed by one component capable of performing all the actions that would be performed by the individual components.

The point of sale processing component 305 is connectable to the multicard transaction system 350 as via a suitable network, such as the public switched telephone network (PSTN) or an independent dedicated network. Each point of sale processing component 305 has an associated identifier that may be transmitted to the multicard transaction system 350 during the course of connecting the point of sale processing component 305 to the multicard transaction system 350.

As depicted in FIG. 3, the multicard transaction system 350 is configured to: (a) form a secure connection with the card vendor system 311, the card issuers' authorization systems 360, and any other entities authorized to access the multicard transaction system 350 by the multicard transaction system administrator 351; (b) access the database 380 to determine the stored-value cards to be activated or deactivated based on the identifier communicated to it by the card vendor; (c) to communicate with card issuers' authorization systems 360 to request and receive activation or deactivation of specific stored-value cards based on the information contained in the database 380 correlating stored-value card identifiers to unique package identifiers; (d) generate and maintain transaction log 370 of all activities performed; (e) generate and maintain an error log 375 of all activities unsuccessfully completed and reasons therefor; (f) communicate to the card vendor the activation or deactivation of the individual stored-value cards and any information concomitant with the activation or deactivation of individual stored-value cards, i.e. the communication of PINs associated with activated stored-value cards; and (g) communicate to the card vendor any reasons why requested transactions cannot not be completed.

Oversight and maintenance of the stored-value card transaction system is performed by the multicard transaction system administrator 351. Although not required, in an alternative embodiment, the multicard transaction system administrator 351 may also function as the database administrator 381.

The multicard transaction system 350 may comprise a singular processing unit, with concomitant storage capability, capable of accessing the database 380, creating and maintaining a transaction log 370, creating and maintaining an error log 375, communicating with the card vendor, communicating with the individual card issuers' authorization systems 360, processing individual stored-value card activation and or deactivation requests, and communicating with other systems 390 capable of and authorized to communicate with the multicard transaction system 350.

In the alternative, the stored-value card transaction system may comprise a plurality of processing units, with concomitant storage capabilities, each capable of: the services described above and in FIG. 2, accessing the database 380; creating a transaction log 370; creating and maintaining an error log 375; communicating with card vendors; communicating with the individual card issuers' authorization systems 360; processing individual stored-value card activation and or deactivation requests; and communicating with other systems 390 capable of and authorized to communicate with the multicard transaction system 350.

In another alternative embodiment, the multicard transaction system 350 may comprise a plurality of processing units, with concomitant storage capabilities, each individually designated for: the services described above and in FIG. 2, accessing the database 380; creating a transaction log 370; creating and maintaining an error log 375; communicating with card vendors; communicating with the individual card issuers' authorization systems 360; processing individual stored-value card activation and or deactivation requests; and communicating with other systems 390 capable of and authorized to communicate with the multicard transaction system 350.

In another alternative embodiment, the stored-value card transaction system may comprise a plurality of processing units, with concomitant storage capabilities: capable of the services described above and in FIG. 2, accessing the database 380, creating a transaction log 370, creating and maintaining an error log 375, communicating with card vendors, communicating with the individual card issuers' authorization systems 360, processing individual stored-value card activation and or deactivation requests, and communicating with other systems 390 capable of and authorized to communicate with the multicard transaction system 350; designated for accessing the database 380, designated for creating a transaction log 370, designated for creating and maintaining an error log 375, designated for communicating with card vendors, designated for communicating with the individual card issuers' authorization systems 360, designated for processing individual stored-value card activation and or deactivation requests, and designated for communicating with other systems 390 capable of and authorized to communicate with the multicard transaction system 350; or any combination thereof.

Upon receipt of an activation or deactivation request, if the received identifier is a package identifier, the multicard transaction system 350 accesses the database 380 of stored-value card identifier data correlated to unique package identifiers. The multicard transaction system 350 processes the information (and if necessary for a package identifier, processes the information along with information contained in the database 380) and communicates 309, 310 with the individual card issuer[‘s’] authorization system[s] 360 to effectuate activation or deactivation of the stored-value card[s] of the request. The multicard transaction system's 350 communication with the individual card issuers' authorization systems 360 may occur simultaneously or independently. The multicard transaction system 350 is connectable to the individual card issuers' authorization systems as via a suitable network, such as the PSTN or an independent dedicated network. The multicard transaction system 350 is configured to receive communication from the card issuers' authorization systems 360 concerning the status of the activation or deactivation of individual stored-value cards.

The multicard transaction system 350 is also configured to generate and maintain a transaction log 370 of all activity involving the multicard activation computer 350. The transaction log may comprise a detailed summary of: (a) requested package activations; (b) requested package deactivations; (c) requested individual card activations; (d) requested individual card deactivations; (e) the monetary amount ascribed to package activations; (f) the monetary amount ascribed to package deactivations; (g) the monetary amounts ascribed individual stored-value card activations; (h) the monetary amounts ascribed to individual stored-value cards deactivations; (i) the identities of the individual card issuers of the stored-value cards secured by activated packages; (j) the identities of the individual card issuers of the stored-value cards secured by deactivated packages; (k) the time the packages were activated; (l) the time the packages were deactivated; (m) the time individual stored-value cards were activated; (n) the time individual stored-value cards were deactivated; (o) the transaction or communication performed with the card issuer to activate the individual stored-value cards; (p) the transaction or communication performed with the card issuer to deactivate the individual stored-value cards; (q) the PIN communicated to the card vendor in response to a request to activate a stored-value card requiring the input of a PIN for use; (r) any other information the multicard transaction system administrator 351 directs the multicard transaction system 350 to maintain as a log entry; and (s) any combination thereof.

The information contained in the transaction log 370 may be used to generate reconciliation reports, settlement reports, payment reports, audit reports, or other forms of information aggregation for the benefit of, use by, or for provision to, the multicard transaction administrator 351, the database administrator 381, card vendors, card issuers, card issuer's authorization systems 360, redeeming merchants, or other interested parties.

The multicard transaction system 350 is configured to generate and maintain an error log of all transactions that were not completed and reasons therefor.

The multicard transaction system 350 is also configured to communicate to the card vendor 307 the status of a request for activation or deactivation of a package identifier and/or individual stored-value cards and to communicate any necessary PIN information required by activated stored-value cards to the card vendor in order for the card purchaser to be apprised of that information for use of the purchased individual stored-value card. As previously discussed, is connectable to the individual card issuers' authorization systems as via a suitable network, such as the PSTN or an independent dedicated network.

The multicard transaction system 350 is also configured to communicate with other entities 390 authorized to access the multicard transaction system and specifically authorized to access the multicard transaction system 350. These other entities may comprise third party payment management systems, third party audit systems, card issuer affiliated entities, card vendor affiliated entities, redeeming merchants or redeeming merchant affiliated entities, or any other entity provided access by the multicard transaction system administrator 351.

In at least one embodiment, there may arise situations where an activation or deactivation request is received by the multicard transaction system 350, but the information in the database 380 pertaining to the package identifier or the individual stored-value card identifiers received by multicard activation computer 350 precludes completion of the request. For example, a package assembly or individual stored-value card may have been previously activated, returned to the point of sale for a refund, but not deactivated prior to reshelving. In that case, when subsequent customer purchases that package assembly or individual stored-value card, and an activation request is communicated to the multicard transaction system 350, the database 380 file accessed by the multicard transaction system 350 will indicate that the package assembly, the individual stored-value cards secured by the package, or or the individual stored-value card are already activated. In this and other similar situations, the multicard transaction system will communicate a message to the card vendor that the transaction cannot be completed.

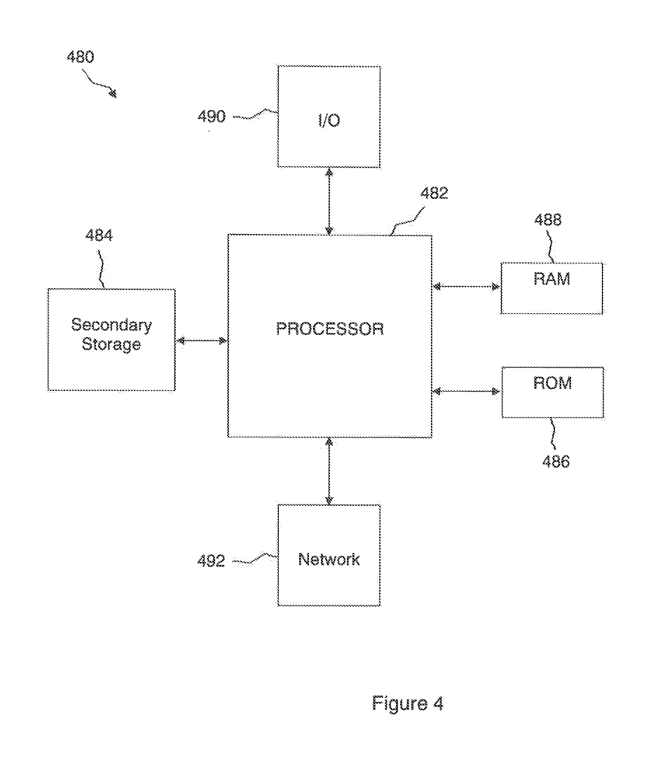

The multicard transaction system 350 above or specific services may be implemented on any particular machine with sufficient processing power, memory resources, and network throughput capability to handle the necessary workload placed upon it. The machine may host one or more services or be part of a group of machines hosting one or more services collectively. FIG. 4 illustrates a particular machine suitable for implementing one or more embodiments or services disclosed herein. The computer system 480 includes a processor 482 (which may be referred to as a central processor unit or CPU) that is in communication with memory devices including secondary storage 484, read only memory (ROM) 486, random access memory (RAM) 488, input/output (I/O) 490 devices, and network connectivity devices 492. The processor may be implemented as one or more CPU chips.

The secondary storage 484 is, in at least one embodiment, comprised of one or more disk drives or tape drives and is used for non-volatile storage of data and as an over-flow data storage device if RAM 388 is not large enough to hold all working data. Secondary storage 484 may be used to store programs which are loaded into RAM 388 when such programs are selected for execution. The ROM 486 is used to store instructions and perhaps data which are read during program execution. ROM 486 is a non-volatile memory device that, in at least one embodiment, has a small memory capacity relative to the larger memory capacity of secondary storage. The RAM 488 is used to store volatile data and perhaps to store instructions. Access to both ROM 486 and RAM 488 is faster than to secondary storage 484 in at least one embodiment.

I/O 490 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 492 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity 492 devices may enable the processor 482 to communicate with an Internet or one or more intranets. With such a network connection, it is contemplated that the processor 482 might receive information from the network, or might output information to the network in the course of performing the above-described method steps. Such information, which is often represented as a sequence of instructions to be executed using processor 482, may be received from and outputted to the network, for example, in the form of a computer data signal embodied in a carrier wave

Such information, which may include data or instructions to be executed using processor 482 for example, may be received from and outputted to the network, for example, in the form of a computer data baseband signal or signal embodied in a carrier wave. The baseband signal or signal embodied in the carrier wave generated by the network connectivity 492 devices may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 482 executes instructions, codes, computer programs, scripts which it accesses from hard disk, floppy disk, optical disk (these various disk based systems may all be considered secondary storage 484), ROM 486, RAM 488, or the network connectivity devices 492.

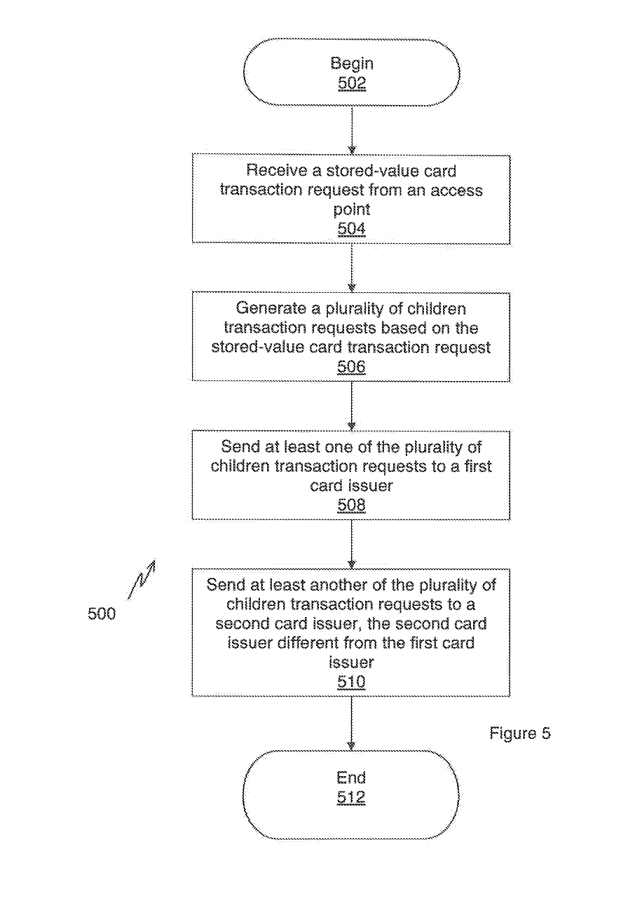

FIGS. 5-8 illustrate various methods for efficient stored-value card transactions. Any step taken by any entity or service described above or in FIGS. 1-4 may be taken from or included in the particular embodiments represented by FIGS. 5-8. FIG. 5 illustrates a method 500 beginning at 502 and ending at 512. At 504, a stored-value card transaction request is received from an access point. Some examples of access points are merchant terminal, customer computer coupled to the Internet, interactive voice response server, customer mobile device coupled to Internet, or customer mobile device coupled to short messaging service (“SMS”). The stored-value card transaction request may comprise an individual stored-value card identification number or indicia thereof or, alternatively, may comprise a package identification number, wherein the package identification number is associated with a plurality of stored-value cards. At 506, a plurality of children transaction requests are generated based on the stored-value card transaction request.

In at least one embodiment, a transaction request comprising an individual card identification number or indicia thereof may result in number of children transaction requests. At 508, at least one of the plurality of children transaction requests is sent to a first card party. At 510, at least another of the plurality of children transaction requests is sent to a second card party.

In at least one embodiment, a number of children transaction requests in the plurality of children transaction requests is equal to a number of stored-value cards in the plurality of stored-value cards. At 508, at least one of the plurality of children transaction requests is sent to a first card party. The first card party is associated with at least one of the plurality of stored-value cards. At 510, at least another of the plurality of children transaction requests is sent to a second card party. The second card party is different from the first card party, and the second card party is associated with at least one of the plurality of stored-value cards.

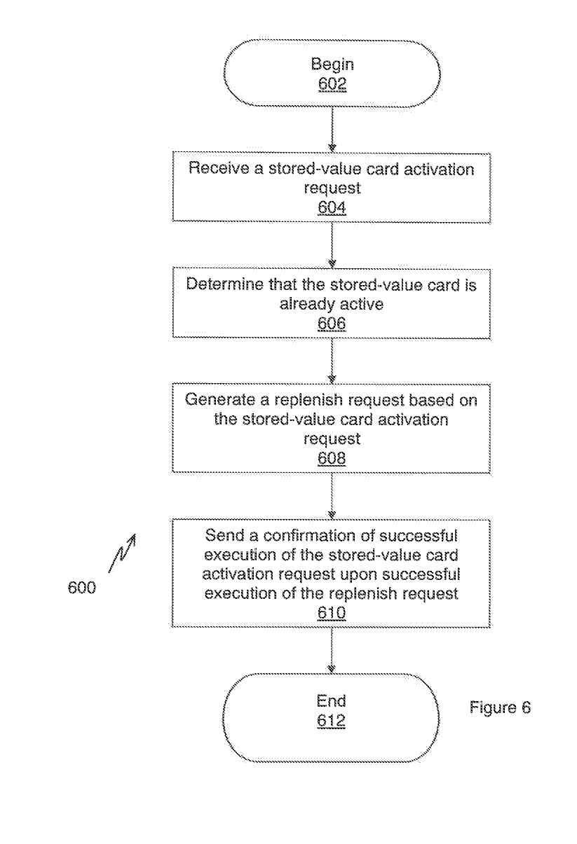

FIG. 6 illustrates a method 600 beginning at 602 and ending at 612. At 604, a stored-value card activation request associated with a stored-value card is received. In at least one embodiment, the method 600 comprises determining that an internal card processing service issued the stored-value card. At 606, a determination is made that the stored-value card is already active. For example, if a phone number is associated with the stored-value card, the card can be assumed to be active. Also, activation of the stored-value card may be attempted. Depending on any returned activation error code, the card may be assumed to be active. At 608, a replenish request is generated based on the stored-value card activation request. For example, if the activation request fails because the card is already active, the activation request may be assumed to have been generated with the intention of replenishment. In at least one embodiment, the replenishment request is executed. At 610, a confirmation of successful execution of the stored-value card activation request is sent upon successful execution of the replenish request.

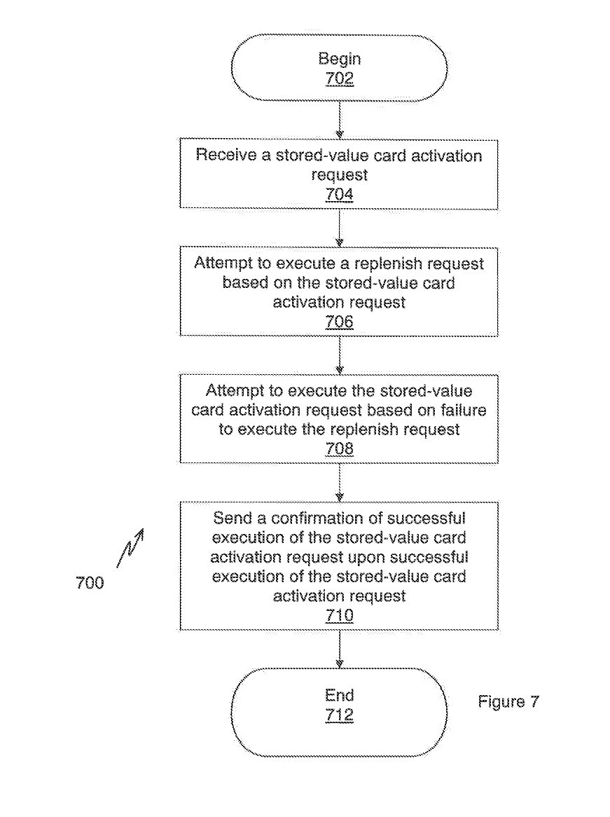

FIG. 7 illustrates a method 700 beginning at 702 and ending at 712. At 704, a stored-value card activation request associated with a stored-value card is received. At 706, an attempt is made to initiate or execute a replenish request based on the stored-value card activation request. Failure to execute the replenish request is caused by the stored-value card being inactive in at least one embodiment. At 708, an attempt is made to initiate or execute the stored-value card activation request based on failure to execute the replenish request. In at least one embodiment, the activation request is executed. At 710, a confirmation of successful execution of the stored-value card activation request is sent upon successful execution of the stored-value card activation request.

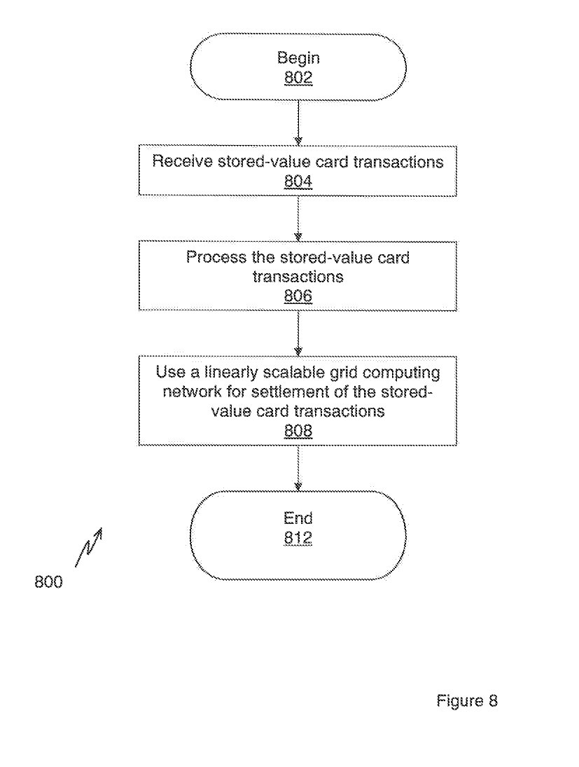

FIG. 8 illustrates a method 800 beginning at 802 and ending at 812. At 804, stored-value card transactions are received. The stored-value card transactions are associated with multiple card issuers. At 806, the stored-value card transactions are processed. If a volume of stored-value card transactions falls below a threshold, a node is added to the linearly scalable grid computing network. For example, another server or switch is made part of a group of servers or switches that are assigned transaction responsibilities or services. If the volume of stored-value card transactions exceeds a threshold, a node is removed from the linearly scalable grid computing network. In other words, the server or switch is rezoned. For example, another server or switch is removed from a group of servers or switches that are assigned transaction responsibilities or services. In other words, the server or switch is rezoned.

At 808, a linearly scalable grid computing network is used for settlement of the stored-value card transactions. In at least one embodiment, using the linearly scalable grid computing network comprises storing and/or processing transaction data associated with the stored-value card transactions on the linearly scalable grid computing network. In various embodiments, using the linearly scalable grid computing network also comprises storing and/or processing summary data associated with the stored-value card transactions, and storing and/or processing master data associated with the stored-value card transactions on the linearly scalable grid computing network. By leveraging data grid, bottlenecks and errors resulting from slow access to a database is prevented. Rather, the data stored on the data grid is asynchronously stored to a database. As such, batch processing can be avoided, but a reference database is still maintained. There is no intentional delay between processing the stored-value card transactions and settlement of the stored-value card transactions and the transactions are settled in real time or near real time.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

It will be apparent to those skilled in the art that modifications may be made without departing from the spirit and scope of the disclosure. The embodiments described are representative only, and are not intended to be limiting. Many variations, combinations, and modifications of the applications disclosed herein are possible and are within the scope of the disclosure. Accordingly, the scope of protection is not limited by the description set out above, but is defined by the claims which follow, that scope including all equivalents of the subject matter of the claims.

What is claimed is:

1. A method, comprising:
receiving a stored-value card transaction request from an access point, the stored-value card transaction request associated with a package identification number, the package identification number associated with a plurality of stored-value cards;
generating a plurality of children transaction requests based on the stored-value card transaction request;
sending at least one of the plurality of children transaction requests to a first card party, the first card party associated with at least one of the plurality of stored-value cards;
sending at least another of the plurality of children transaction requests to a second card party, the second card party different from the first card party, the second card party associated with at least one of the plurality of stored-value cards.

2. The method of claim 1, wherein a number of children transaction requests in the plurality of children transaction requests is equal to a number of stored-value cards in the plurality of stored-value cards.

3. The method of claim 1, wherein the access point is selected from the group consisting of merchant terminal, customer computer coupled to the Internet, interactive voice response server, customer mobile device coupled to Internet, or customer mobile device coupled to short messaging service (“SMS”).

4. The method of claim 1, wherein the first card party and the second card party are the same card party.

5. The method of claim 1, further comprising using hardware comprising a linearly scalable grid computing network for settlement of the stored-value card transactions.

6. A network, comprising:
an acquiring transaction service;
an internal card processing service coupled to the acquiring transaction service;
wherein the acquiring transaction service receives a stored-value card activation request associated with a stored-value card;
wherein the acquiring transaction service generates a replenish request, based on the stored-value card activation request, and sends the replenish request to the internal card processing service;
wherein the internal card processing service determines that the stored-value card is already active;
wherein the acquiring transaction service sends a confirmation of successful execution of the stored-value card activation request upon successful execution of the replenish request.

7. The network of claim 6, wherein the acquiring transaction service determines that the internal card processing service issued the stored-value card.

8. The network of claim 6, wherein the internal card processing service sends a phone number associated with the stored-value card to the acquiring transaction service.

9. The network of claim 6, wherein the acquiring transaction service generates a second replenish request formatted for card party associated with the stored-value card.

10. The network of claim 6, wherein the acquiring transaction service sends a redemption request to the internal card processing service.

11. The network of claim 6, wherein the internal card processing service generates a second replenish request formatted for card party associated with the stored-value card.

12. A method, comprising:
receiving stored-value card transactions from a hardware access point;
processing the stored-value card transactions;
using hardware comprising a linearly scalable grid computing network for settlement of the stored-value card transactions.

13. The method of claim 12, further comprising adding a node to the linearly scalable grid computing network if a volume of stored-value card transactions falls below a threshold.

14. The method of claim 12, further comprising removing a node from the linearly scalable grid computing network if a volume of stored-value card transactions exceeds a threshold.

15. The method of claim 12, wherein data stored on the linearly scalable grid computing network is asynchronously stored to a database.

16. The method of claim 12, wherein the stored-value card transactions are associated with multiple card issuers.

17. The method of claim 12, wherein there is no intentional delay between processing the stored-value card transactions and settlement of the stored-value card transactions.

18. The method of claim 12, wherein using the linearly scalable grid computing network comprises storing transaction data associated with the stored-value card transactions on the linearly scalable grid computing network.

19. The method of claim 12, wherein using the linearly scalable grid computing network comprises storing summary data associated with the stored-value card transactions on the linearly scalable grid computing network.

20. The method of claim 12, wherein using the linearly scalable grid computing network comprises storing master data associated with the stored-value card transactions on the linearly scalable grid computing network.
